(19) United States
(12) Patent Application Publication
(10) Pub. No.: US 2025/0361094 A1
(43) Pub. Date: Nov. 27, 2025

(54) Method for operating a conveyor apparatus, conveyor apparatus and use

(71) Applicant: Deutsche Post AG, Bonn (DE)

(72) Inventors: Viktor Kuznecov, Siegburg (DE); Frank Fisser, Köln (DE)

(21) Appl. No.: 19/213,009

(22) Filed: May 20, 2025

(30) Foreign Application Priority Data
May 22, 2024 (DE) 10 2024 114 342.8

(51) Int. Cl. B65G 43/02

(52) U.S. Cl. CPC B65G 43/02; B65G 2203/0275; B65G 2203/041; B65G 2203/044

(57) ABSTRACT

A method for operating a conveyor apparatus for conveying objects is disclosed. The conveyor apparatus includes a circulating conveyor line with one or more movable conveyor devices for supporting the objects, and a maintenance device for recording the conveyor line, the method includes moving the maintenance device along the conveyor line, recording the conveyor line using the maintenance device for obtaining information relating to a top side and/or a bottom side of the conveyor line, and comparing the obtained information with previously known information about the conveyor line for localizing a geometric deviation in the conveyor line.

The present application is based upon and claims the right of priority to DE Patent Application No. 10 2024 114 342.8, filed May 22, 2024, the disclosure of which is hereby incorporated by reference herein in its entirety for all purposes.

The invention relates to a method for operating a conveyor apparatus for conveying objects. The invention also relates to a conveyor apparatus for conveying objects and to a use.

It is known that conveyed objects can become stuck or lost in a conveyor apparatus. This firstly compromises the conveyor apparatus itself or proper operation of the conveyor apparatus. Secondly, proper transportation of the objects is compromised.

Furthermore, conveyor apparatuses have to be regularly serviced and repaired if necessary. For this purpose, a conveyor apparatus regularly has to be switched off, complex manual activities have to be performed and proper occupational safety has to be ensured.

Proceeding from here, the objective of the invention is to provide solutions with which conveying or transportation of objects in conveyor apparatuses is more successful. In particular, maintenance and repair in conveyor apparatuses is to be improved. In particular, disadvantages in solutions known from the prior art are to be avoided or at least substantially reduced.

This objective is achieved by the subject matter of the independent patent claims. In particular, the invention is defined in the independent patent claims. Preferred developments of the invention can be found in the dependent claims, in the figures and in the following description.

The invention in conjunction with conveyor apparatuses can be used to reduce downtimes. Occupational safety during maintenance and repair and the durability of the conveyor apparatuses can likewise be improved. The invention may contribute to the conveyor apparatus being able to be operated at higher speed or conveying speed because it is possible to react to problems more quickly. The refinements of the invention can further improve the aforementioned advantages.

In particular, a conveyor apparatus for conveying objects, having a circulating conveyor line with one or more movable conveyor devices for supporting the objects is proposed. The conveyor device can be guided movably along the conveyor line. A large number of conveyor devices and a maintenance device for recording the conveyor line can be movably guided along the conveyor line lined up in a row. In particular, the conveyor apparatus has a/the maintenance device for recording the conveyor line, or a plurality of maintenance devices. In particular, the conveyor devices are each designed for unloading an object lying thereon or conveyed thereon transversely to the conveyor line. In particular, the conveyor device has a detection device which is permanently installed on the conveyor line and is designed for recording the conveyor device and/or an object. The maintenance device has, in particular, a sensor system for recording the conveyor line for obtaining information relating to a top side and/or a bottom side of the conveyor line. The maintenance device has, in particular, an actuator device for carrying out maintenance work on the conveyor line.

For example, the independent patent claim directed to the conveyor apparatus proposes a conveyor system or else a cross belt sorter which has a maintenance cell or a maintenance unit for inspecting the conveyor line, wherein, in particular on the basis of the inspection, historical information can be compared with current information in order to be able to locate problem areas or deviations along the conveyor line.

In particular, a method for operating a/the conveyor apparatus is proposed, the method comprising: moving the maintenance device(s) and preferably the conveyor device(s) along the conveyor line, and recording the conveyor line using the maintenance device for obtaining the information, and in particular comparing the obtained information with previously known information about the conveyor line for checking the function and/or orientation of the detection device and/or for localizing a geometric deviation in the conveyor line.

For example, the independent patent claim directed to the method proposes an operating method of a conveyor system or else a cross belt sorter, wherein a maintenance cell or maintenance unit is provided for inspecting the conveyor line. In the method, the conveyor cells and the maintenance cell are moved together or at the same speed, including standstill, while the conveyor cell inspects the conveyor line or sorter line or records it by sensor, and wherein, on the basis of the inspection, historical information can be compared with current information in order to be able to locate problem areas or deviations along the conveyor line. Therefore, problem areas can be identified in particular during normal operation of the cross belt sorter, thereby making it possible to reduce the downtime.

In particular, a use is proposed of a, for example remotely controllable, maintenance device having a sensor system for recording a conveyor line of a conveyor apparatus designed for conveying objects for obtaining information relating to a top side and/or a bottom side of the conveyor line and/or having a sensor system for recording a conveyor line of a conveyor apparatus designed for conveying objects for localizing a geometric deviation in the conveyor line and/or with a sensor system for recording a conveyor line of a conveyor apparatus designed for conveying objects for checking the function and/or orientation of a detection device which is permanently installed on the conveyor line and is designed for recording the conveyor device and/or an object, and/or having an actuator device for carrying out maintenance work on a conveyor line of a conveyor apparatus designed for conveying objects. The use provides in particular operation of the conveyor apparatus moving the conveyor line and the maintenance device at the same speed. The conveyor apparatus can have in particular conveyor devices which are lined up in a row and can each be designed for unloading an object lying thereon transversely to the conveyor line.

For example, the independent patent claim directed to the use proposes the use of a maintenance cell in a conveyor system, wherein the maintenance cell has for locating problem areas or local deviations of the conveyor line of the conveyor system. The maintenance cell and the conveyor cells are moved or operated together or at the same speed, including standstill.

The conveyor apparatus typically refers to a system that is intended to transport objects from one location to another and/or to distribute them between locations. The conveyor apparatus is typically automated, this in particular including control via computer systems. The conveyor apparatus may comprise, for example, belts, rollers, rails, drives and/or other technical means in order to convey the objects. For example, the conveyor apparatus may have a moving conveyor belt, in particular wherein the conveyor belt is to be understood to mean a conveyor device.

The conveyor apparatus is arranged or provided in particular in a production plant, post distribution centre, letter distribution centre and/or other logistical and/or producing facilities. In particular, the conveyor apparatus may be provided in a storage or production hall, for example for conveying objects as stored goods and/or production goods.

“Objects” may be consignments or any transport goods or objects that can be moved on a conveyor line. For example, the objects may be items of luggage, suitcases, cans, bottles, goods, commercial goods, a stream of material, bulk goods or the like.

Objects, in particular in the form of consignments, can comprise packages, parcels, letters, mail, palletized goods and the like. The object typically relates to packaged or unpackaged items and/or documents. The object is intended in particular to be transported or distributed using the conveyor apparatus. Objects may be of different sizes and weights or have different characteristics. The object may comprise: envelope, document envelope, letter envelope, padded envelope, packaging material, carton and/or pallet. The object typically weighs at least one gram. The object may weigh several kilograms, for example 10, 20, 30, 50 or more kilograms. The object may have a size of between one or several millimeters up to one or several centimeters, decimeters or meters in one direction. The packaging of the object may be configured to protect the contents of the object against damage during transportation or distribution. The object or its packaging may be padded and/or mechanically reinforced. The object may be wrapped with adhesive tape or packaging tape.

It has been recognized that poorly or unfavorably packed objects, for example with protruding packaging material, adhesive tape or other projections, or else narrow objects can get stuck in the conveyor apparatus. The invention can remedy this by way of the maintenance apparatus.

It is possible for the object to be equipped with a locating system in order to monitor and/or control its movement during conveying, in particular in the conveyor apparatus. However, there is often no locating system, which is why the present invention seeks to remedy this problem by way of the maintenance apparatus. In this respect, the maintenance apparatus may have a locating system.

The circulating conveyor line relates, in particular, to a part of the conveyor apparatus that can move the objects in a continuous circuit and/or along a defined route. This conveyor line may have a conveyor belt or belt, a chain and/or a rail configuration which optionally allows the objects to return to the starting point again. For example, the conveyor line may be designed with a view to adjustability of a speed or conveying speed and/or integration of sorting and processing stations along the conveyor line. It is possible for stations, e.g. automated loading stations and/or unloading stations, to be integrated or linked in order to increase functionality. The conveyor line typically has a/the top side and a/the bottom side. The top side and the bottom side in particular face away from each other, for example wherein the conveyor device separates the top side and the bottom side from each other. The top side may be referred to as the first side and the bottom side may be referred to as the second side. The objects are typically located on the top side or first side.

The conveyor device is a moving part of the conveyor apparatus, a part of the conveyor apparatus to be moved and/or a part of the conveyor apparatus intended to move objects. Typically, the conveyor apparatus has one or more drives which can move the conveyor device(s). A plurality of drives can be arranged distributed along the conveyor line. The conveyor device can be moved in a conveying direction or main transportation direction and/or be designed for moving objects in this direction. The conveying direction can run in a straight line and/or in a curve at least in sections. For example, the conveying direction forms a continuously closed or at least substantially endless, in particular annular, circuit. The conveying direction can run between ends and/or be branched. An annular circuit with branching may also be provided.

The conveyor device can be understood to mean conveyor means of the conveyor line, the conveyor means in particular being intended to be in contact with objects lying thereon or resting thereon. The conveyor line can be designed as a conveyor belt or have a conveyor belt. In this respect, the conveyor device can be a conveyor belt with a support for one or more objects and possibly for the maintenance device. The conveyor device is designed, in particular, for transporting one or more objects. A plurality of conveyor belts may be provided. The conveyor line can be designed as a roller conveyor or have a roller conveyor. In this respect, the conveyor device can be designed as a driven and/or freely rotating roller for moving objects, wherein in particular a plurality of rollers are provided in this case.

A or the large number of conveyor devices may be provided. The conveyor device may be one of many modular conveyor elements of the conveyor apparatus, wherein each conveyor element can be provided for conveying individual objects. The large number of the conveyor devices or conveyor elements can be provided lined up along the conveyor line or conveying direction and, in particular pivotably, coupled to each other. In this respect, the conveyor devices can form a circulating or continuous chain. The conveyor devices can then be moved together or at the same speed. The maintenance device can be surrounded along the conveying direction from the front and rear by a conveyor devices in each case and in particular can be coupled to the conveyor device, in particular in a similar or the same way as conveyor devices are coupled to each other. The conveyor device and/or the maintenance device can be rail-guided. The conveyor line can have a rail for the conveyor device(s) and possibly the maintenance device(s).

The maintenance device relates, for example, to a system or an apparatus which is intended to monitor or diagnose the state and functioning of the conveyor line and/or to assist in doing so. The maintenance device can contain sensors, cameras and/or other instruments that can record information about the state of the conveyor line. The maintenance device can be remotely controllable, which can mean in particular at least transmission of the information away from the maintenance device to a computer device, for example for remote control, and optionally remote operation of the maintenance device. The maintenance device can be designed to transmit the information. The information can be analyzed in particular on the maintenance device itself and/or elsewhere, for example in order to plan maintenance work and/or to identify problems before they lead to disruption. The maintenance device can comprise software tools which are configured to visualize the information and/or can provide recommendations for maintenance intervals and repairs.

The maintenance device can be battery-powered and/or fed with electricity along the conveyor line or from the conveyor line. The maintenance device can be understood to mean an unmanned vehicle and/or object, in particular which can move along the conveyor line, preferably with the conveyor device or the conveyor devices, in particular at the same speed. The maintenance device can have its own drive and/or be driven by the conveyor line.

Insofar as the conveyor device is designed for unloading an object lying thereon or conveyed thereon transversely to the conveyor line, it can be referred to as a cross belt conveyor or cross belt sorter, or sorter. The cross belt conveyor is a conveyor system that is typically designed to move objects primarily along the conveying direction as the main transportation direction and transversely to the conveying direction during unloading. In particular, the system allows objects to be shifted and/or distributed laterally to the conveying direction, either to bring the objects to a standstill, to distribute them to another handling station and/or to move them to another conveyor apparatus. The cross belt conveyor typically has a large number of transversely arranged conveyor belts or tiltable carriages which are moved along the conveying direction. The conveyor belts or carriages can be moved independently of each other to unload the objects, in order to unload and/or distribute objects at specific points and/or stations.

The conveyor apparatus can be designed as a tray sorter. This tray sorter has a large number of conveyor devices with a mechanism which conveys and ejects the objects with carriers in the form of trays or chambers. The tray sorter can be designed as a tilting tray sorter, as a split tray sorter or as a push tray sorter.

The conveyor apparatus, in particular the cross belt conveyor, may comprise as detection device(s) integrated scanners or other identification systems which participate in conveying the objects, in particular sorting and distributing the objects. The detection device refers in particular to a permanently installed monitoring and/or identification system, which is designed, for example, to record various sections and/or parts of the conveyor line and/or objects located thereon. The detection device can have one or more components such as light barriers, cameras, sensors, scanners or other measuring devices, which can in particular continuously collect data about the state of the conveyor devices and the properties of the transported objects. The detection device is typically permanently integrated and/or directly connected to the conveyor line, as a result of which detection, monitoring and/or data acquisition permanently or at any time is possible. The detection device can identify, for example, dimensions, weight, type, position and/or state of an object. The detection device and/or the maintenance device can identify or localize technical states or malfunctions of the conveyor line. The information obtained from the detection device is typically used when distributing objects. If a detection device is not functioning or is incorrectly oriented, this can lead to disruption during operation and/or the conveyor apparatus may come to a standstill.

The sensor system for recording the conveyor line relates in particular to sensors, sensor arrangements and/or devices with sensors which are designed to collect information about the top side and/or bottom side of the conveyor line. The sensor system is designed in particular for recording the conveyor line or is specially configured for this purpose. The sensor system can be used to identify features such as a three-dimensional extent, a state of wear, damage/defects or other structural properties of the conveyor line. The sensor system can comprise at least one camera, one optical sensor, ultrasonic sensor, radar sensor, laser sensor, lidar sensor, infrared sensor and/or tactile sensor in order to be able to obtain the information. Different sensors may be expedient, depending on the application.

The sensor system can be configured such that it measures static and/or dynamic properties, such as for example vibration patterns of the conveyor line, which can provide information about the on-going operating state.

The actuator device comprises in particular a movable system or auxiliary means, which can carry out maintenance and repair work on the conveyor line. The actuator device can comprise various types of actuators, in particular robot arms, tool carriers and/or special modules or tools that can be used for maintenance work such as lubrication, cleaning, repair, replacement of worn parts or adjustments. The actuator device is equipped, for example, with a control system which is configured in particular for control based on the obtained information and/or based on user commands. The actuator device or the control system can be programmed to carry out maintenance work, for example in order to not disturb the operation of the conveyor apparatus or to do so to the least possible extent. The maintenance device, in particular with the actuator device, can contribute to increasing the availability of the conveyor apparatus by way of reducing the need for manual intervention and basically carries out intervention itself. At the same time, the maintenance device, in particular with the actuator device, can improve occupational safety by way of keeping people away from potentially hazardous maintenance tasks.

Comparison of the obtained information with previously known information about the conveyor line is in particular a computer-implemented method step. Comparison relates in particular to a target-actual comparison. Firstly, the actual environment can be recorded and, secondly, the actual environment can be compared with an original or desired target environment. For example, if there are sufficient deviations between the information, a geometric deviation can be inferred. It is possible to identify not only the presence of the geometric deviation, but also its location based on the obtained information. Localization means in particular identifying and locating the deviation. Comparison is advantageously used to check the function or orientation of the detection device. Here, too, deviations between actual and target provide corresponding indications that the detection device is not correctly oriented or is not functioning.

Further possible refinements of the invention, which can be advantageously used in the conveyor apparatus and the method, are specified below.

The maintenance device is, for example, a device carried along on the conveyor line. The maintenance device can be mounted or placed on a conveyor device. The maintenance device can be fixed in particular on a support of a conveyor device. The maintenance device can also be movably guided along the conveyor line lined up in a row on one or more conveyor devices, in particular wherein the maintenance device can form an integral constituent part of the conveyor line in this case. In this respect, a conveyor device can be replaced with the maintenance device.

The conveyor apparatus can have a detection device, which is permanently installed on the conveyor line. The detection device can be fixed in position, i.e. it cannot be moved together with the conveyor device(s) when it/they are moved. The detection device can have a sensor and/or a light barrier, for example by way of which objects can be recorded and/or measured. The detection device is typically arranged or oriented at a certain height and/or at a certain angle with respect to the conveyor device(s). The detection device can be adjusted. When the detection device is functioning properly, it can for example record objects at a certain height and/or identify whether the respective conveyor device is conveying an object.

The sensor system can have a camera on the top side and/or a camera on the bottom side. For example, the sensor system or the camera can be oriented in the conveying direction and/or opposite to the conveying direction, and/or pointing upward or downward. The sensor system can be directed toward the nearest conveyor device(s). The sensor system can record in particular an enclosure of the conveyor line. The sensor system can provide an image or video signal as information. The signal from the camera makes it possible for points requiring maintenance, objects that have been left behind, geometric deviations in the conveyor line or the like to be identified.

The sensor system can advantageously have a lighting device for illuminating the conveyor line. The lighting device is designed in particular for illuminating the conveyor line or is specially configured for this purpose. The lighting device has, for example, an LED light source, in particular in conjunction with a reflector for the light emerging from the LED light source. A camera can be combined with the lighting device in order to obtain a particularly bright or high-contrast image or video signal from the often poorly lit interior parts of the conveyor apparatus.

In particular, the sensor system can be directionally adjustable by motor. For example, the camera and the lighting device can be directionally adjusted together. An adjusting motor can be provided. For example, provision can be made for the sensor system to be able to be directionally adjusted in a range of action of at least 45°, preferably at least 90°, preferably at least 180°, in particular 360°. For example, the range of action can extend in a horizontal plane of the conveyor line and around a vertical axis. In this respect, the sensor system can be rotated by up to one complete revolution around the vertical axis. The sensor system can optionally also be directionally adjusted around one or two further axes in space. Thus, an inspection can be carried out in a targeted manner starting from the maintenance device along the conveyor line, in particular during operation of the conveyor apparatus.

A remote control arrangement can be provided for remotely controlling or remotely operating the conveyor line and/or the maintenance device. The remote control arrangement is designed in particular for remote control or remote operation or is specially configured for this purpose. The remote control arrangement is designed in particular for displaying the information, for example using a display. The remote control arrangement can be designed as a mobile and/or battery-powered device. The remote control arrangement can be provided by a computer device, for example a laptop, smartphone and/or tablet computer. The remote control arrangement typically has an input device, for example a keyboard and/or a touchscreen, and/or an output device, for example a display and/or loudspeaker. The remote control arrangement can be configured for example to directionally adjust the sensor system and/or specify a conveying speed and/or conveying direction of the conveyor line. The remote control arrangement is designed in particular for communicating with the maintenance device, for example in order to transmit the information and/or send control commands. The communication is preferably wireless and/or bidirectional communication, for example using a wireless communication method such as 4G, 5G, WLAN and/or Bluetooth. The remote control arrangement makes it easier to service or repair the conveyor apparatus.

A visualization device is preferably provided. The visualization device can have a display and/or a projection apparatus, for example in order to display or visualize the information. The visualization device is designed in particular for displaying the information using augmented reality and/or virtual reality. The visualization device can have 3D glasses, VR glasses or the like. The visualization device can, in particular wirelessly and/or bidirectionally, communicate for example with the remote control arrangement and/or the maintenance device, for example using a/the wireless communication method such as 4G, 5G, WLAN and/or Bluetooth.

A locating device is preferably provided for ascertaining a position of the maintenance device along the conveyor line. In particular, the maintenance device has a marker in order to visually mark a position of the maintenance device. The marker may be a prominent element, for example a flag. As an alternative or in addition, a luminaire may be provided as the marker. The locating device can also have a loudspeaker in order to output sounds.

As an alternative or in addition, the locating device can ascertain a position of the maintenance device along the conveyor line and provide the position as part of the information. A user can more easily identify the point at which the maintenance device is located using the locating device.

The conveyor line can have an enclosure, in particular to cover the conveyor device laterally and/or at the bottom. The enclosure can be provided at least in sections along the conveyor line. The enclosure can have openings or flaps in order to gain access to the conveyor line, in particular from the lateral direction, in sections. The enclosure preferably has at least one side wall or two opposite side walls. A gap, for example with a width of at least 0.5 cm and, for example, at most 10 cm, can be provided between the conveyor device and the enclosure or side wall. The enclosure can be designed for lateral delimiting or as an edge boundary of the conveyor line. The enclosure can serve as an edge boundary at the sides of the conveyor device(s). The enclosure can also be arranged below the conveyor device in sections. The enclosure provides in particular lateral protection and possibly protection from above or below. The enclosure protects in particular the moving conveyor device against unintentional human intervention.

The maintenance device advantageously has an, in particular remotely operable, actuator device. The actuator device is designed in particular for carrying out maintenance work on the conveyor line or is specially configured for this purpose. The actuator device is designed in particular for carrying out movements in space or relative to the conveyor line. For example, the maintenance device can be remotely operated using a/the remote control arrangement, wherein the actuator device can carry out a controlled movement and/or maintenance work in the process. For example, the actuator device can be designed for replacing, moving and/or deforming parts or sections of the conveyor apparatus and/or objects or is specially configured for this purpose. The actuator device is typically distinguished in that it can carry out an actuated relative movement with respect to the conveyor line or to a conveyor device, in particular with respect to the maintenance device itself away from the actuator device. The actuator device can be designed to be electrically, hydraulically and/or pneumatically controllable. A plurality of actuator devices can also be provided, for example one or more actuator devices on the top side and/or one or more actuator devices on the bottom side. The actuator device typically has one or more drives.

The actuator device can advantageously have a robot arm or be formed by a robot arm, in particular wherein the robot arm is provided with the sensor system and/or a tool preferably for moving an object or has the sensor system and/or a tool. The tool is designed in particular for moving an object or is specially configured for this purpose. The tool can have a gripper, for example. A plurality of tools can be provided, in particular on a robot arm. The robot arm typically has a plurality of mutually spaced-apart pivot axes and at least one robot arm element having at least two of the pivot axes. Experience has shown that a robot arm is very flexible in terms of incidental repairs and maintenance work.

In the method proposed here, a geometric deviation can be localized by comparing the obtained information with the previously known information. The geometric deviation can comprise an object that has been left behind and/or is stuck. As an alternative or in addition, the geometric deviation can comprise an at least partially opened and/or defective enclosure of the conveyor line. The geometric deviation can also be in particular coarse soiling. It has been found that these geometric deviations are a common source of faults during operation of the conveyor apparatus. In addition, it has been found that these geometric deviations can be readily identified with the presented method. For example, the conveyor line can be monitored and/or inspected during operation by means of comparison in order to quickly identify problems and eliminate their cause.

In the method proposed here, the function and/or orientation of the detection device can be checked by comparing the obtained information with the previously known information. For example, it is possible to ascertain the height at which the detection device or the light barrier is set, how it is oriented and/or whether it is functioning properly. Signal checking of the detection device can be carried out. Overall, the functionality of the conveyor apparatus can thus be checked, for example in order to be able to intervene in the event of irregularities. For example, the conveyor line can be recorded in a section with the detection device. The previously known information can relate in particular to the detection device or the section with the detection device. In this respect, comparison can focus on the detection device in order to ensure its function.

The conveyor line can be recorded all around. For example, the conveyor line can be recorded continuously, with each run and/or substantially permanently in order to be able to react to problems in real time to the greatest extent possible. Therefore, as an alternative or in addition, the conveyor line may be recorded at regular time intervals, for example hourly or daily, in order to save resources.

Operation and recording and optionally comparison can be carried out at the same time. The steps of the method can overlap in time or else can be carried out in succession. In principle, recording can be carried out during movement and also independently of movement. Comparison can also be delayed in time, for example by way of the information first being collected and being evaluated by comparison later. Operation, recording and comparison are preferably carried out at the same time in order to be able to identify problems on the conveyor line as quickly as possible.

The maintenance device can be fixed on and/or under the conveyor device, in particular can be fixed to it. For example, the maintenance device can be attached and/or secured to the respective conveyor device. This ensures that the obtained information is as consistent as possible at different times. The consistency of the obtained information can also be improved in conjunction with the enclosure.

It is possible for the previously known information to be generated by initially recording the conveyor line using the maintenance device. Initial recording is preferably carried out when the conveyor line is operationally ready for conveying objects and is in an initial state. In other words, the conveyor line should be fault-free and in an ideal state when the previously known information is recorded. It is also conceivable for obtained information to be made into previously known information in order to be able to identify spontaneously occurring and/or minimal geometric deviations.

In the method, the maintenance device can be remotely operated, in particular wherein the information is displayed and/or stored using a/the remote control arrangement and/or a/the visualization device, which is designed to display the information using augmented reality and/or virtual reality. For example, a user can remotely control the conveyor line in order to move the maintenance device to the geometric deviation and/or to the detection device, in particular while the user gains a view into the interior of the conveyor apparatus.

In the method, the maintenance device can carry out maintenance work. The maintenance work can be executed by a user command and/or in a user-controlled manner. The maintenance work can comprise repairing the conveyor line and/or moving an object that has been left behind and/or orienting and/or checking the function of the detection device. For example, parts of the conveyor apparatus can be inspected, repaired and/or replaced. The detection device can be vertically adjusted and/or signal checking of the detection device can be carried out. In the method, provision can ultimately be made for maintenance or repair to be carried out on the conveyor line. In particular, a local defect, for example an object that has been left behind, a geometric deformation and/or an adjusted detection device, can be eliminated by user operation with the aid of the actuator device and in particular in a manner controlled using the remote control arrangement and/or the visualization device. For example, the maintenance device can set or adjust the detection device, in particular automatically.

Data relating to the maintenance work carried out can be stored in a database. Repeated maintenance work can be carried out in an automated manner taking into account the stored data. The database can be provided by the maintenance device, the remote control arrangement, a central computer device and/or a cloud. In particular, a learning system can be provided, in which maintenance work or repairs that has/have already been carried out is/are stored and can be automatically executed later in the event of reoccurrence in accordance with a pattern that is already known. Repeated maintenance work can relate not only to repairs, but also objects that have been left behind or are stuck or orienting or checking the detection device. For example, it is possible for maintenance and/or repair of a certain point of the conveyor line to be carried out in an automated manner when the maintenance device has been trained accordingly. For example, lubrication of certain mechanical parts can be automated. It is also possible for points in the conveyor apparatus that are susceptible to objects becoming stuck to be worked in an automated manner by moving the object using the maintenance device.

The geometric deviation can comprise in particular coarse soiling and/or a point to be cleaned or a soiled point of the conveyor line. The maintenance device can be designed for cleaning the conveyor line and/or the detection device. For example, the maintenance device can have a cleaning means or a cleaning tool, for example a brush or a compressed-air nozzle for directed output of compressed air. The robot arm can be designed for cleaning. For example, the cleaning means or cleaning tool can be used on the conveyor line using the robot arm. In the method, cleaning can be provided by the maintenance device, for example cleaning the conveyor line and/or the detection device, in particular with mechanical contact (e.g. brush) and/or contactlessly (e.g. compressed air).

Within the context of the disclosure, the German abbreviation “bzw.” represents a short form of “beziehungsweise” [respectively; or] and is intended in principle to indicate alternative, basically equivalent and/or synonymous features or terms in order to introduce the idea or the sense of a use of a feature or term. “Beziehungsweise” can always be replaced by “und/oder” [and/or].

The invention is explained further in detail below using a preferred exemplary embodiment with reference to the drawings.

In the drawings,

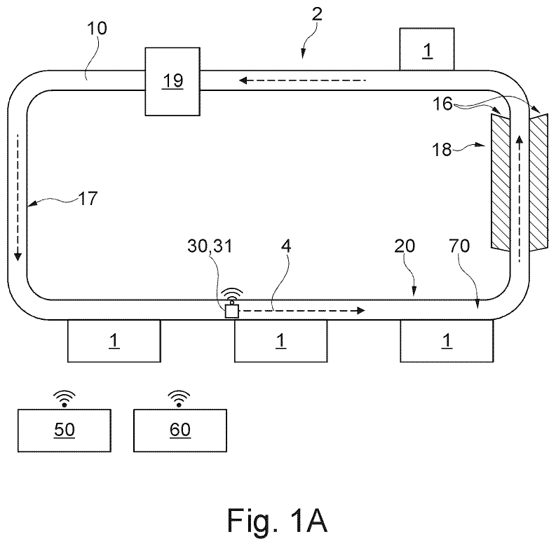

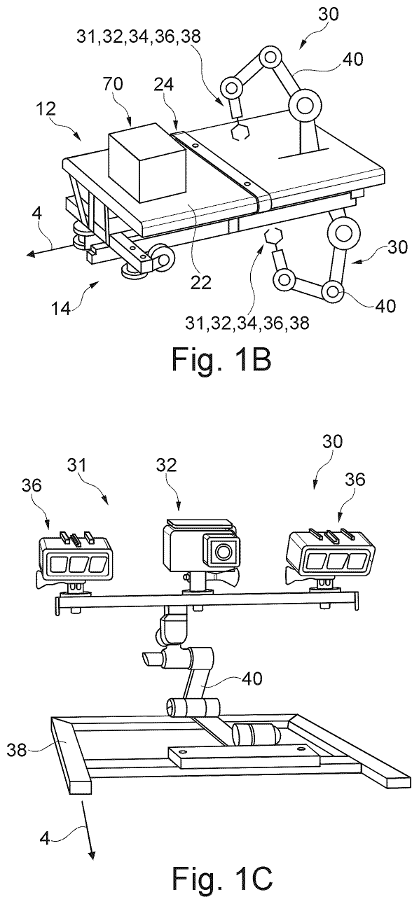

FIG. 1A shows a schematic view of a conveyor apparatus for conveying objects and having maintenance devices,

FIG. 1B shows a perspective view of a maintenance device and a conveyor device of the conveyor apparatus, the conveyor device being coupled to the maintenance device lined up in a row, and

FIG. 1C shows a perspective view of a maintenance device of the conveyor apparatus.

FIG. 1A shows a conveyor apparatus 2, which is designed for conveying objects 70, having a conveyor line 10 circulating endlessly or in an annular or circular manner along a conveying direction 4. A large number of conveyor devices 20, not shown in detail, and a maintenance device 30 are movably guided lined up in a row or coupled to each other along the conveyor line 10. Drives 17 along the conveyor line can move this chain comprising the conveyor devices 20 and the maintenance device 30 onward in a circulating manner.

A further maintenance device 30 is mounted on one of the conveyor devices 20 or fixed on it. The conveyor devices 20 are each designed for unloading an object 70 lying thereon or conveyed thereon transversely to the conveyor line 10. A plurality of sorting or processing stations 1 are connected to the outside of the conveyor line 10, it being possible for objects 70 to be loaded from the sorting or processing stations onto the conveyor devices 20 or unloaded from the conveyor devices 20 to the stations 1. In particular, the conveyor apparatus 2 is designed as a cross belt sorter or cross belt conveyor. As an alternative or in addition, the conveyor apparatus 2 is designed as a tray sorter.

In the present case, the maintenance devices 30 are remotely controllable or remotely operable maintenance devices, i.e. the maintenance devices 30 can send information and optionally receive and execute commands.

A conveyor apparatus having a conveyor line is not shown, with exactly one conveyor device being movably guided along the conveyor line. For example, this could be a belt conveyor, wherein a maintenance device is mounted on the belt conveyor or is fixed to it and is conveyed with it. The belt conveyor can be designed to circulate endlessly or else as a line section with at least two ends.

A conveyor apparatus having a conveyor line is not shown, wherein a plurality or a large number of conveyor devices for conveying objects are arranged movably along the conveyor line. For example, this could be a roller conveyor, wherein a maintenance device is mounted on the roller conveyor and is conveyed with it. The roller conveyor can be designed to circulate endlessly or else as a line section with at least two ends.

Furthermore, provision is made in FIG. 1A for a detection device 19, which is permanently installed on the conveyor line 10 and has a top-side light barrier, for example with the function of recording objects 70 at a certain height or not recording objects, depending on the height. The detection device 19 is adjustable or can be oriented.

The conveyor line 10 has an enclosure 16 in order to cover the conveyor devices 20 and the maintenance devices 30 laterally and optionally at the bottom side. The enclosure 16 can be opened in sections, for example using covers 18 or flaps, in order to gain access to the conveyor line 10. The covers 18 or flaps can be understood to mean fences.

It is possible for objects 70 to become stuck between conveyor devices 20 and the enclosure 16 or enter a gap. These objects are referred to as an object 70 that has been left behind or a consignment that has been left behind. If objects 70 are comparatively flat, they can also reach the region below the conveyor line 10, that is to say the bottom side.

FIG. 1B shows, in a detail of the conveyor apparatus 2 of FIG. 1A, a single conveyor device 20 which is coupled to the maintenance device 30 lined up in a row so as to move together. The conveyor devices 20 each have a support 22 for supporting the objects 70, which support can be tilted transversely to the conveying direction 4 for unloading the respectively supported objects 70 and/or is a conveyor belt which is oriented transversely to the conveying direction 4 and can discharge or unload the respectively supported objects 70 transversely to the conveying direction 4. The conveyor devices 20 are coupled to each other and similarly the conveyor device 20 shown is coupled to the maintenance device 30 in a coupling region 24. The coupling region 24 creates room for movement, for example in bends of the conveyor line 10.

In the present case, the maintenance device 30 of FIG. 1B, like the conveyor devices 20, is rail-guided and can be moved with the conveyor devices 20 at the same speed. The maintenance device 30 can be regarded as a maintenance cell. In the present case, the maintenance device 30 has two remotely controllable actuator devices 40 which are designed for carrying out maintenance work on the conveyor line 10, wherein the actuator devices 40 each have a robot arm, and wherein the respective robot arm is provided with a sensor system 31 and a tool for grasping and moving an object 70.

The tool can have a suction device and/or an apparatus for grasping objects 70 using vacuum. Objects 70 can thus be selectively drawn by suction in order to be temporarily fixed to the tool and be able to be moved.

The sensor system 31 is respectively designed for recording the conveyor line 10 for obtaining information relating to a top side 12 and a bottom side 14 of the conveyor line 14. The sensor system 31 has a camera 32 on the top side 12 and a camera 34 on the bottom side 14. Furthermore, the sensor system 31 has a lighting device 36 for illuminating the conveyor line 10, preferably from the inside and/or in the field of view of the camera 32, 34. The sensor system 31 is directionally adjustable by motor. In particular, the camera 32, 34 and/or the respective robot arm can be directionally adjusted.

The maintenance device 30 optionally has a locating device 38 for ascertaining a position of the maintenance device 30 along the conveyor line 10. The maintenance device 30 has a marker, for example a flag, in order to visually mark a position of the maintenance device 30, in particular in a manner easily identifiable from the outside.

FIG. 1C shows the further maintenance device 30 of the conveyor apparatus 2, the further maintenance device being able to be fixed on a conveyor device 20, for example being able to be placed on and/or attached to it, in order to be moved along the conveying direction 4. The maintenance device 30 has a camera 32 on the top side 12 and at least one lighting device 36. The camera 32 and the lighting device 36 are optionally directionally adjustable via an actuator device 40. Instead of or in addition to the actuator device 40, a manually adjustable arm can also be provided.

Looking at FIG. 1A, a remote control arrangement 50 is provided, which is designed for remotely operating the conveyor line 10 and the maintenance devices 30, in particular the actuator devices 40, wherein the remote control arrangement 50 is designed to display the information. The maintenance devices 30 can send the information. The remote control arrangement 50 can store the information, for example in a database. The remote control arrangement 50 is designed for wireless communication with the maintenance devices 30 and optionally with the conveyor line 10. The conveyor apparatus 2 can be moved in particular by a user input and/or a camera 32, 34 or one of the robot arms can be directionally adjusted via the remote control arrangement 50. The information obtained from the sensor system 31 is at least partially visible on the remote control arrangement 50. For example, a user can identify whether and where an object 70 has become stuck.

The remote control arrangement 50 used may be a smartphone, a tablet and/or a computer with a screen, which can communicate with the maintenance device or the maintenance devices 30 via a wireless communication method, for example 4G, 5G, WLAN and/or Bluetooth.

A visualization device 50, which is designed for displaying the information using augmented reality and/or virtual reality, is optionally provided. The visualization device may be VR glasses worn by a user servicing the conveyor apparatus 2. The visualization device can communicate in cooperation with the remote control arrangement 50 or on its own with the maintenance device or the maintenance devices 30 in order to display the contents and/or control the conveyor line 10 and/or the maintenance device 30. The visualization device 50 can communicate with the maintenance device or the maintenance devices 30 and/or the remote control arrangement 50 via a wireless communication method, for example 4G, 5G, WLAN and/or Bluetooth.

An operating method of the conveyor apparatus 2 comprises moving the maintenance device 30 or maintenance devices 30 along the conveyor line 10, in particular by way of moving the conveyor devices 20. The maintenance device 30 is moved in particular by force exerted by the drive 17 and in particular via the conveyor devices 20. In particular, the operating method is at least partially computer-implemented.

The operating method further comprises recording the conveyor line 10 using the maintenance device(s) 30 for obtaining the information. The sensor system 31 records the top side 12 and the bottom side 14, so that a user can see into hard-to-reach and/or enclosed points in the conveyor line 10.

The operating method further comprises comparing the obtained information with previously known information about the conveyor line 10. Comparison is provided, for example, for checking the function and orientation of the detection device 19 and for localizing a geometric deviation in the conveyor line 10. The geometric deviation may be an object 70 that has been left behind or is stuck or else soiling and a partially opened or defective enclosure 16.

In the operating method, the conveyor line 10 is recorded all around using the maintenance device 30. This enables rapid identification of whether and where there is a geometric deviation. Operation, recording and comparison are preferably carried out at the same time, wherein in particular recording and comparison are predominantly or substantially computer-implemented steps.

As an alternative or in addition, the conveyor line 10 is recorded in the section with the detection device 19, wherein the previously known information relates to the detection device 19. Basically, the operating method can be focused on the inspection or maintenance of the detection device 19 here.

In the operating method, the maintenance device 30 can carry out maintenance work using the actuator device 40, wherein the maintenance work comprises repair of the conveyor line 10 and moving an object 70 that has been left behind and orienting and checking the detection device 19. It is possible for data relating to the maintenance work carried out to be stored in a database, wherein repeated maintenance work can be carried out in an automated manner taking into account the stored data. The maintenance device 30 or its actuator device 40 is remotely controllable in particular using the remote control arrangement 50. A user can advantageously use the visualization device 60 in order to display the geometric deviation as a superimposition on the conveyor apparatus 2 in its field of view. Thus, the user can remotely control the maintenance device 30 from the outside in a targeted manner in order to remove or repair the geometric deviation or to carry out maintenance work.

The operating method further provides generating the previously known information by initially recording the conveyor line 10 using the maintenance device 30 when the conveyor line 10 is operationally ready for conveying objects 70 and is in an initial state. In this respect, a correct original state or factory state of the conveyor line 10 can be retained in order to be able to readily identify geometric deviations in the obtained information.

The maintenance device 30 has various possible applications. In the operating method, objects 70 that have been left behind can be moved using the maintenance device 30. Soiling can be identified as geometric deviations using the maintenance device 30 and in particular can be eliminated by cleaning using the maintenance device 30. The detection device 19 can, if it is adjusted, be oriented using the maintenance device 30. The maintenance device 30 can be used to identify an opened enclosure 16, for example open safety devices, and if necessary to close them or to report this. The maintenance device 30 can be used to identify damage to the enclosure 16 or to side walls and if necessary to repair them or to report this.

In particular, the invention illustrates and describes a development wherein a maintenance cell or maintenance device 30, for example one such as that from FIG. 1B, is introduced instead of a sorter cell or conveyor device 20 in a sorter or a conveyor apparatus 2, in particular a cross belt sorter or cross belt conveyor. The maintenance cell is distinguished in that the environment can be concomitantly recorded by sensor, in particular photo-optically by cameras 32, 34, above and below the sorter or the conveyor line 10, that is to say on the top side 12 and the bottom side 14. Remote operability of the maintenance cell and the sorter is provided. Soiling, objects 70 that have been left behind, defects, missing covers and the like can be identified in a manually operated process. A user or operator can wear the visualization device 60 in the form of VR glasses and/or make observations about the maintenance cell from the computer. The maintenance cell or maintenance device 30 can observe the conveyor line 10 in sections and/or continuously when the conveyor apparatus 2 is operated. It is possible to determine in an automated manner whether and where an object 70 has become stuck or other geometric deviations or maintenance needs have arisen, e.g. at the detection device. This is achieved in particular by the automated target-actual comparison by the method step “comparing”. In other words, for example, environmental differences can be compared, this being able to be achieved on account of a target environment of the conveyor line, which is defined at least in sections, in particular owing to an enclosure 16. The position of a “problem area” (stuck object 70/object left behind, geometric deviation, detection device to be checked or set, etc.) can be automatically localized in order to be able to plan or carry out appropriate maintenance work or repairs.

A further embodiment of the development provides for the maintenance device 30, for example one such as that from FIG. 1C, to be moved by one or more conveyor devices 20 in a conveyor apparatus 2. The conveyor apparatus 2 can be a conveyor belt and/or a roller conveyor. In principle, provision can be made for the maintenance device 30 to be concomitantly moved or conveyed like an object 70. In this case, the maintenance device 30 can concomitantly record the environment by sensor, for example photo-optically by a camera 32, at least above the conveyor line 10 of the conveyor apparatus 2 or on the top side 12. Remote operability and/or features, as explained in the previous paragraph, can be provided here too.

The invention illustrates and describes a method for operating a conveyor apparatus 2 for conveying objects 70, the conveyor apparatus 2 having a circulating conveyor line 10 with one or more movable conveyor devices 20 for supporting the objects 70, and a maintenance device 30 for recording the conveyor line 10, the method comprising moving the maintenance device 30 along the conveyor line 10, recording the conveyor line 10 using the maintenance device 30 for obtaining information relating to a top side 12 and/or a bottom side 14 of the conveyor line 10, and comparing the obtained information with previously known information about the conveyor line 10 for localizing a geometric deviation in the conveyor line 10.

The invention illustrates and describes a use of an, in particular remotely controllable, maintenance device having a sensor system 31 for recording a conveyor line 10 of a conveyor apparatus 2 designed for conveying objects 70 for localizing a geometric deviation in the conveyor line 10 during operation of the conveyor apparatus 2 moving the conveyor line 10 and the maintenance device 30 at the same speed.

### LIST OF REFERENCE SIGNS

2 Conveyor apparatus
4 Conveying direction
10 Conveyor line
12 Top side
14 Bottom side
16 Enclosure
17 Drive
18 Cover
19 Detection device
20 Conveyor device
22 Support
24 Coupling region
30 Maintenance device
31 Sensor system
32 Camera (top side)
34 Camera (bottom side)
36 Lighting device
38 Locating device
40 Actuator device
50 Remote control arrangement
60 Visualization device
70 Object

1. A method for operating a conveyor apparatus for conveying objects, the conveyor apparatus having a circulating conveyor line with one or more movable conveyor devices for supporting the objects, and a maintenance device for recording the conveyor line, the method comprising:
moving the maintenance device along the conveyor line,
recording the conveyor line using the maintenance device for obtaining information relating to at least one of a top side and a bottom side of the conveyor line, and
comparing the obtained information with previously known information about the conveyor line for localizing a geometric deviation in the conveyor line.

2. The method according to claim 1, wherein the geometric deviation comprises at least one of an object that at least one of has been left behind and is stuck and at least one of a partially opened and defective enclosure of the conveyor line.

3. The method according to claim 2, wherein comparison is provided for checking at least one of a function and orientation of a detection device which is permanently installed on the conveyor line and is designed for recording at least one of the conveyor device and an object.

4. The method according to claim 3, wherein the detection device has at least one of a sensor and a light barrier and is arranged on the top side.

5. The method according to claim 4, wherein the conveyor line is recorded all around.

6. The method according to claim 1, wherein operation and recording are carried out simultaneously.

7. The method according to claim 1, wherein a large number of conveyor devices and the maintenance device are movably guided along the conveyor line lined up in a row, wherein the conveyor devices are each designed for unloading an object lying thereon transversely to the conveyor line.

8. The method according to claim 1, wherein the maintenance device is fixed at least one of on the, under the conveyor device and is fixed to the conveyer device.

9. The method according to claim 1, wherein the conveyor line has an enclosure in order to laterally cover the conveyor device.

10. The method according to claim 1, comprising generating the previously known information by initially recording the conveyor line using the maintenance device when the conveyor line is operationally ready for conveying objects and is in an initial state.

11. The method according to claim 1, wherein the maintenance device has a sensor system for recording the conveyor line for obtaining information relating to at least one of a top side and a bottom side of the conveyor line.

12. The method according to claim 1, wherein the maintenance device has an actuator device for carrying out maintenance work on the conveyor line.

13. The method according to claim 12, wherein the actuator device has a robot arm or wherein the robot arm at least one of is provided with the sensor system and has a tool.

14. The method according to claim 1, wherein the maintenance device is remotely operated and the information is at least one of displayed and stored using at least one of a remote control arrangement and a visualization device, which is designed to display the information using at least one of augmented reality and virtual reality.

15. The method according to claim 1, wherein the maintenance device carries out maintenance work, and wherein the maintenance work comprises at least one of repairing the conveyor line and moving an object that has been left behind or at least one of orientating and checking the detection device.

16. The method according to claim 15, wherein data relating to the maintenance work carried out is stored in a database, and wherein repeated maintenance work is carried out in an automated manner taking into account the stored data.

17. The method according to claim 1, wherein the sensor system has at least one of a camera on the top side and a camera on the bottom side.

18. The method according to claim 1, wherein the sensor system has a lighting device for illuminating the conveyor line, wherein the sensor system is directionally adjustable by motor.

19. A conveyor apparatus for conveying objects, which is designed to execute the method according to claim 1.
